(19) United States
(12) Patent Application Publication
(10) Pub. No.: US 2010/0028202 A1
(43) Pub. Date: Feb. 4, 2010

(54) PROACTIVE CONTROL SYSTEM FOR AN INDUSTRIAL WATER SYSTEM

(76) Inventors: Zhaoyang WAN, Yardley, PA (US); Gary E. Geiger, Richboro, PA (US); Glenn Johnson, Devon, PA (US); Simon Craig Norton, Sandbach (GB); Anthony Michael Rossi, Lower Alloways Creek, NJ (US); William Weaver Thompson, Wenonah, NJ (US)

Correspondence Address: General Electric Company;GE Global Patent Operation, PO Box 861, 2 Corporate Drive, Suite 648, Shelton, CT, 06484, US

(21) Appl. No.: 12/182,642

(22) Filed: Jul. 30, 2008

(51) Int. Cl. G05D 21/00; C02F 5/00

(52) U.S. Cl. 422/62

(57) ABSTRACT

A control system is disclosed for monitoring and controlling an industrial water system comprising (a) obtaining a priori knowledge about the correlation between water and treatment chemistry and equipment health; (b) pre-defining a set of operating regions of more than one feed-water or system water variable and at least one chemical treatment variable, where, based on (a) above, corrosion, scaling and fouling are inhibited; (c) adjusting the at least one chemical treatment variable according to the more than one feed water or system water variable, such that based on (a), corrosion, scaling and fouling are inhibited.

### FIELD OF THE INVENTION

The field of the invention relates to accumulation and analysis of real time data, and proactively maximizing corrosion/scaling/fouling inhibition and particulate dispersancy performance while minimizing cost of water and treatment chemicals so as to result in a more effective and efficient industrial water system. In particular it relates to real time controls for industrial water systems, such as but not limited to, cooling water systems, boiler systems, water reclamation systems and water purification systems.

### BACKGROUND OF THE INVENTION

Abundant supplies of fresh water are essential to the development of industry. Enormous quantities are required for the cooling of products and equipment, for process needs, for boiler feed, and for sanitary and potable water supply. It is becoming increasingly apparent that fresh water is a valuable resource that must be protected through proper management, conservation, and use. In order to insure an adequate supply of high quality water for industrial use, the following practices must be implemented: (1) purification and conditioning prior to consumer (potable) or industrial use; (2) conservation (and reuse where possible); and/or (3) wastewater treatment.

The solvency power of water can pose a major threat to industrial equipment. Corrosion reactions cause the slow dissolution of metals by water and eventually structural failure of process equipment. Deposition reactions, which produce scale on heat transfer surfaces and which can cause both loss of energy efficiency and loss of production, represent a change in the solvency power of water as its temperature is varied. The control of corrosion and scale is a major focus of water treatment technology.

Typical industrial water systems are subject to considerable variation. The characteristics of water composition can change over time. The abruptness and degree of change depend upon the source of the water. Water losses from a recirculating system, changes in production rates, and chemical feed rates all introduce variation into the system and thereby influence the ability to maintain proper control of the system.

Usually, a large proportion of the total amount of contaminant that enters a cooling or boiler system on a mass basis does so during compressed time frames, when contaminant levels are abnormally high. These are known as upset conditions, when contaminant levels may be at many times their “average” or background level in the feedwater or system water. One example of an upset condition includes the entry of untreated make-up water into a cooling or boiler system due to a pretreatment malfunction or failure. Another example is a large quantity of iron oxide entering a cooling or boiler system due to a sudden corrosion event in the cooling or boiler system, which can be a result of a sudden ingress of corrosive substances into the system. These events may be for brief or extended periods of time.

As upsets enter into feed water or a system water, various control strategies are formulated in order to minimize the impact of the upsets on equipment health in terms of corrosion, deposition and fouling. There are four categories of control strategies: (1) feed water feed-forward control; (2) system water feed-forward control; (3) treatment chemical feedback control; (4) performance feedback control.

Control strategies for the first two categories, (1) feed water feed-forward control and (2) system water feed-forward control, are based on feed water or system water to determine chemical feed levels are feed-forward and proactive in nature. Although the knowledge about the correlation between water and treatment chemistry and equipment health must be obtained before these control strategies can be implemented, the knowledge once obtained can help determine the correct chemical treatment to prevent upsets from being passed on and impacting equipment health.

The latter two control strategies, (3) treatment chemical feedback control and (4) performance feedback control, are based on direct performance measurements or treatment chemicals' responses to performance changes upon upsets are feedback and reactive in nature. Although they are easy to implement without the need for a priori knowledge about the correlation between water and treatment chemistry and equipment health, disturbances must upset the equipment health and corrosion, scaling and fouling must already be actively occurring in the system before the feedback controller can react or respond to the upset condition in an appropriate manner to prevent further system damage due to said corrosion, deposition or fouling. Since corrosion, scaling and fouling are highly inter-correlated, once initiated, one can trigger and intensify the other two. This interaction between corrosion, deposition and fouling will typically require an increase, often very substantial, in the requirement or “system demand” for chemical treatment to prevent further damage to the equipment.

Control strategies based on (1) feed water feed-forward and (2) system water feed-forward are superior to those based on (3) treatment chemical feedback and (4) performance feedback because maintaining the health of an industrial water system proactively is more economical than trying to fix an unhealthy one reactively. The following provides a detailed survey of the existing control strategies and their classifications.

Typically, given a particular calcium ion content in water, a treatment comprised of an inorganic orthophosphate together with a water soluble polymer is used to form a protective film on metallic surfaces in contact with aqueous systems, in particular cooling water systems, to thereby protect such from corrosion. The water soluble polymer is critically important to control calcium phosphate crystallization so that relatively high levels of orthophosphate may be maintained in the system to achieve the desired protection without resulting in fouling or impeded heat transfer functions which normally are caused by calcium phosphate deposition. Water soluble polymers are also used to control the formation of calcium sulfate and calcium carbonate and additionally to dispense particulates to protect the overall efficiency of water systems.

U.S. Pat. No. 5,171,450 established a simplified recognition that the phenomenon of scaling or corrosion in cooling towers can be inhibited by selection of an appropriate polymer, or combination of polymers, as the treating agent. This was based on the fact that losses of the active polymer as a consequence of attrition due to protective film formation on equipment or avoiding deposits by adsorbing onto solid impurities to prevent agglomeration or crystal growth of particulates which can deposit on the equipment. In this patent, the active polymer is defined as the polymer measured by its fluorescent tags, and active polymer loss is defined by using an inert chemical tracer (measure of total product concentration) and subtracting active polymer concentration as indicated from tagged polymer level. Thus, the control of corrosion and scaling is accomplished by control of active polymer at a level where active component losses are not excessive.

In U.S. Pat. No. 6,153,110, polymer inhibition efficiency was defined, i.e. the ratio of free polymer level to total polymer level. In defining free and total polymer levels, the polymer lost from the system undetected by sampling the system water was excluded initially, then free polymer was defined as unreacted polymer, and bounded polymer was defined as both polymer associated with inhibited particles (functioning as a scale inhibitor) and polymer absorbed onto undeposited scale (functioning as a dispersant). The free and bounded polymer together comprised the total polymer present in the water system. A correlation was established between % polymer inhibition efficiency and % scale inhibition, and between % polymer inhibition efficiency and % particulate dispersion. Thus, the control of scaling and deposition was accomplished by controlling at the required ratio of free polymer level to total polymer level.

Both U.S. Pat. No. 5,171,450 and U.S. Pat. No. 6,153,110 describe treatment chemical feedback control systems that use polymer consumption, either in forms of difference between total polymer and active polymer or ratio between free polymer and total polymer, as the treatment chemicals' response to equipment health changes upon upsets, thus they propose reactive control systems. U.S. Pat. Nos. 5,171,450 and 6,153,110 describe reactive control systems in that they increase polymer dosing as a result of losing active polymer.

U.S. Pat. Nos. 6,510,368 and 6,068,012 propose performance based control systems by directly measuring performance parameters such as corrosion, scaling and fouling on simulated detection surfaces. Although the proposed methods deal with some of the disadvantages of chemical treatment feedback control, such as monitoring an inert chemical tracer leads to control wind down of active chemicals and monitoring active chemicals leads to control wind up of total chemical feed, neither chemical monitoring methods provide assurance for site specific performance. In both U.S. Pat. Nos. 6,510,368 and 6,068,012, decision trees were developed to identify from performance measurements the causes of performance degradation and then take corrective actions accordingly. In terms of pH upset, performance feedback control systems increases polymer dosage after phosphate has precipitated on the detection surface as a result of phosphate crystallization, and therefore they are reactive control systems.

Traditional types of cooling and boiler treatment chemical controls can be described as feedforward control based on feed water and system water demand. Examples within the industry include a suitable polymeric dispersant fed in proportion to the level of feedwater contaminant, as well as in proportion to the rate of feedwater or blowdown flow. This chemistry and method of feed is well-known and widely practiced, and insures that there are sufficient polymeric dispersant in relation to the major contaminants, typically hardness (calcium and magnesium) and iron oxide, to effectively minimize deposition on the cooling and boiler heat transfer surfaces and to effectively maximize rejection of the contaminants from the system through the blowdown streams or “bleed off” that are removed continuously or intermittently from the system to prevent excessive concentration of dissolved or suspended solids. Although this control algorithm falls into the control categories (1) feed water feedforward or (2) system water feedforward, the incorporation of knowledge about a priori knowledge of the correlation between water and treatment chemistry and equipment health rarely goes beyond a single variable, such as flow rate, mainly because of lack of real time sensors and lack of computing power in a controller.

A key disadvantage of (3) treatment chemical and (4) performance feedback methods is that they are reactive instead of proactive, in other words, an error must be detected in a controlled variable before the feedback controller can take action to change the manipulated variable. As such, disturbances must upset the system and corrosion, scaling and fouling are already actively occurring in the system before the feedback controller can do anything. Moreover, corrosion, scaling and fouling are highly inter-correlated. Once commenced, one will trigger and intensify the other two, which may demand three or four times more chemicals to bring the system back to its performance baseline, thus resulting in an uneconomical consumption of chemicals. Maintaining the health of an industrial water system proactively is more economical than trying to fix an unhealthy one. Therefore, a need exists within the industry for a control system that is proactive instead of reactive, and therefore results in more efficient and economical processes.

In addition, as more real time sensors for water chemistry detection are developed, there is a need for a control system which maximizes its proactiveness to upsets by incorporating a priori knowledge of the correlation between water and treatment chemistry and equipment health, while minimizing reactiveness to pass upsets' impact on equipment health, thus resulting in more efficient and economical processes.

### SUMMARY OF THE INVENTION

Disclosed are control systems that utilize multiple measurements of information and a priori knowledge of the correlation between water and treatment chemistry and equipment health, proactively adjusts chemical treatments to compensate for upsets in feed or system water chemistry, maximize corrosion/scaling/fouling inhibition and particulate dispersancy performance, and minimize cost of water and treatment chemicals. The system is capable of automatic operation for a wide range of process conditions, ensures multiple performance objectives, achieves robust operation under a variety of unmeasurable disturbances, and achieves the least costly solution delivery.

In one embodiment of the present invention, a control system is disclosed for monitoring and controlling an industrial water system comprising (a) obtaining a priori knowledge about the correlation between water and treatment chemistry and equipment health; (b) pre-defining a set of operating regions of more than one feed water or system water variable and at least one chemical treatment variable, where, based on (a) above, corrosion, scaling and fouling are inhibited; (c) adjusting the at least one chemical treatment variable according to the more than one feed water or system water variable, such that based on (a), corrosion, scaling and fouling are inhibited.

The various features of novelty which characterize the invention are pointed out with particularity in the claims annexed to and forming a part of this disclosure. For a better understanding of the invention, its operating advantages and benefits obtained by its uses, reference is made to the accompanying drawings and descriptive matter. The accompanying drawings are intended to show examples of the many forms of the invention. The drawings are not intended as showing the limits of all of the ways the invention can be made and used. Changes to and substitutions of the various components of the invention can of course be made. The invention resides as well in sub-combinations and sub-systems of the elements described, and in methods of using them.

### BRIEF DESCRIPTION OF THE DRAWINGS

FIG. 1 is an illustration of a classification of control algorithms;

FIG. 2 demonstrates control of active polymer at a fixed target does not necessarily prevent deposition of phosphate to the system under pH upsets;

FIG. 3 depicts various operating zones for an illustrative water treatment program;

FIG. 4 is an example of predefined operating regions in a boiler system correlating feed water chemistry with feed water treatment chemistry; and

FIG. 5 is a comparison between a control system with a priori knowledge and a control system without a priori knowledge of the correlation between pH and target polymer concentration.

### DETAILED DESCRIPTION OF THE INVENTION

Approximating language, as used herein throughout the specification and claims, may be applied to modify any quantitative representation that could permissibly vary without resulting in a change in the basic function to which it is related. Accordingly, a value modified by a term or terms, such as “about”, is not limited to the precise value specified. In at least some instances, the approximating language may correspond to the precision of an instrument for measuring the value. Range limitations may be combined and/or interchanged, and such ranges are identified and include all the sub-ranges included herein unless context or language indicates otherwise. Other than in the operating examples or where otherwise indicated, all numbers or expressions referring to quantities of ingredients, reaction conditions and the like, used in the specification and the claims, are to be understood as modified in all instances by the term “about”.

As used herein, the terms “comprises,” “comprising,” “includes,” “including,” “has,” “having” or any other variation thereof, are intended to cover a non-exclusive inclusion. For example, a process, method, article or apparatus that comprises a list of elements is not necessarily limited to only those elements, but may include other elements not expressly listed or inherent to such process, method article or apparatus.

Disclosed are control systems that utilize multiple measurements of information and a priori knowledge of the correlation between water and treatment chemistry and equipment health. Based on the a priori knowledge, the control systems proactively adjust chemical treatments to compensate for upsets in feed or system water chemistry, maximize corrosion/scaling/fouling inhibition and particulate dispersancy performance, and minimize cost of water and treatment chemicals. The system is capable of automatic operation for a wide range of process conditions, ensures multiple performance objectives, achieves robust operation under a variety of unmeasurable disturbances, and achieves the least costly solution delivery.

In one embodiment of the present invention, a control system is disclosed for monitoring and controlling an industrial water system comprising (a) obtaining a priori knowledge about the correlation between water and treatment chemistry and equipment health; (b) pre-defining a set of operating regions of more than one feed-water or system water variable and at least one chemical treatment variable, where, based on (a) above, corrosion, scaling and fouling are inhibited; (c) adjusting the at least one chemical treatment variable according to the more than one feed water or system water variable, such that based on (a), corrosion, scaling and fouling are inhibited.

The control system can be used over a variety of different industrial water systems, including, but not limited to, a recirculating system, a cooling tower system, and a boiler system.

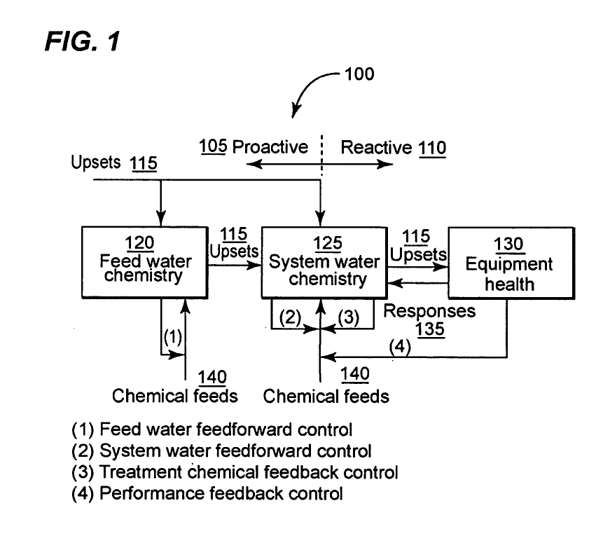

A fundamental difference between this invention and what is known from the prior art is that the presently claimed process is proactive and optimal in assuring site specific performance. An embodiment of the presently claimed control system is based on a comprehensive view of the industrial water system and its control structure. FIG. I is a flowchart 100 classification of control algorithms. Control algorithms are classified as either proactive 105 or reactive 110. As shown in FIG. 1, upsets 115 can enter into feed water 120 or system water 125. The upsets 115, if not compensated by treatment chemicals 140, will pass from feed water 120 to system water 125 and ultimately impact equipment health 130 in the form of corrosion, deposition and fouling on equipment surface. In a proactive control system 105 such as (1) feed water feed-forward and (2) system water feed-forward, treatment chemicals 140 are added to the system 100 based on feed water 120 or system water 125 conditions before upsets 115 can impact equipment health 130. This is known as feedforward control, which anticipates upsets 115 impact on equipment health 130 and provides additional treatment chemicals 140 to prevent upsets 115 from impacting equipment health 130.

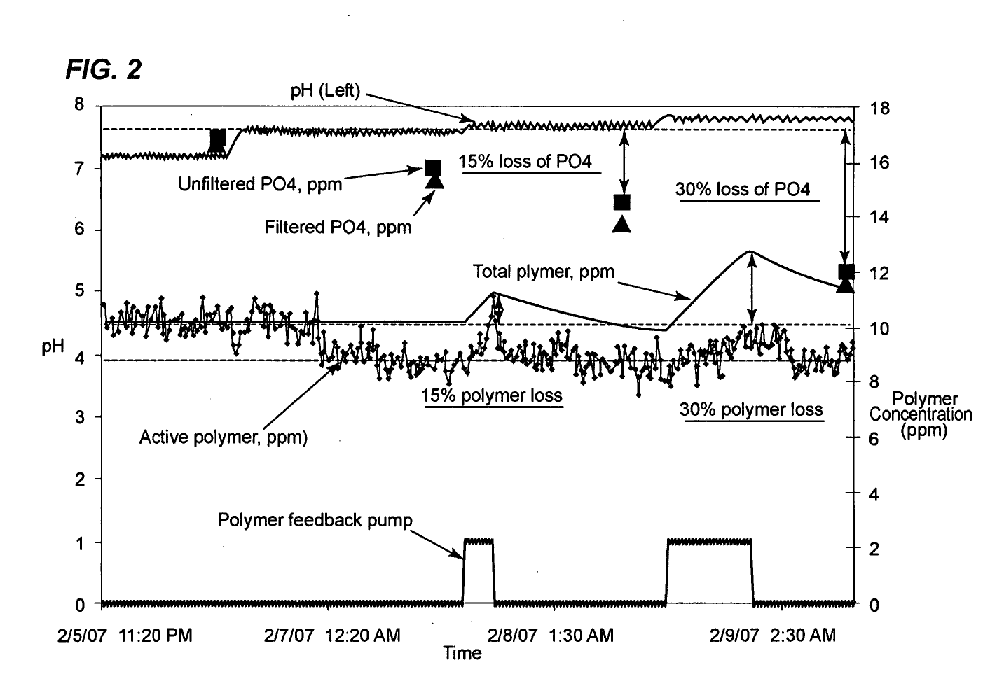

Alternatively, in a reactive control system 110 such as (3) treatment chemical and (4) performance feedback, addition of treatment chemicals 140 occurs when an impact of an upset 115 on equipment health 130 has been detected. This is known as feedback control, which provides additional treatment chemicals 140 only after the impact of upsets 115 on equipment health 130 leads to a deviation of a controlled variable from its target. FIG. 2 demonstrates a polymer feedback control system under pH upset. Active polymer is controlled at 4 ppm. As pH increases, the tendency of phosphate to precipitate increases, thus there is an increasing loss of phosphate and polymer attached to precipitated phosphate. The duration of polymer pump ON time increases, which implies an uneconomical use of polymer to fix the unhealthy system. Although an active polymer target can be increased to minimize polymer loss, a treatment chemistry feedback control needs polymer loss (i.e. deviation of active polymer from its target of active and total polymer) to decide its control action. Because the feedback control relies on polymer loss as a result of phosphate loss to make control decisions, the uneconomic consumption of polymer is a necessary part of total uses of polymer.

FIG. 2 demonstrates that pH upset lead to deposition of phosphate, which in turn, leads to loss of active polymer as a response to deposition of phosphate upon pH upsets. FIG. 2 also demonstrates that control of active polymer at a fixed target does not necessarily prevent deposition of phosphate to the system upon pH upsets. On the other hand, a proactive control system 105 with (1) feed water feed-forward control or (2) system water feed-forward control would immediately respond to pH upsets by increasing polymer dosing to an appropriate level according to a priori knowledge, thus preventing phosphate loss and subsequent polymer loss.

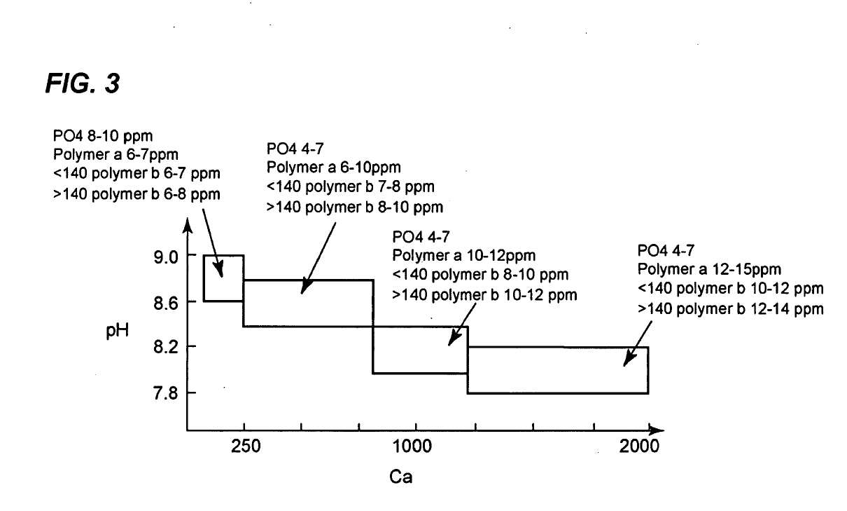

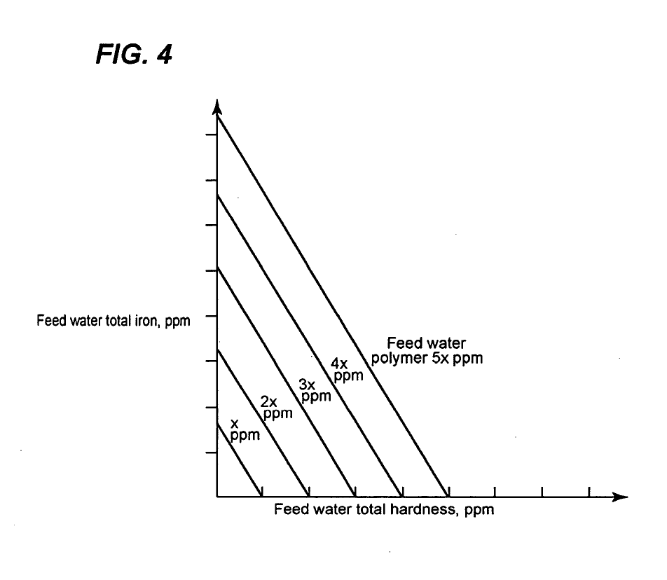

In the present invention, a priori knowledge is obtained by theoretically or empirically correlating water and treatment chemistry to equipment health. An example of theoretical correlation between water chemistry and equipment health is a super-saturation index model, which provides thermodynamic solubility limits of various hardness salts. An example of empirical correlation is demonstrated in FIGS. 3 and 4. FIG. 3 depicts various operating zones, also known as operating regions, for an illustrative cooling water treatment program, coordinating system water chemistry with treatment chemistry so that within each region, corrosion and deposition are inhibited. The set of operation regions are an empirical representation of the underlying interdependency among pH, hardness, phosphate, alkalinity, and polymer. For corrosion inhibition, a lower hardness requires a higher pH and a higher phosphate level to accomplish controlled precipitation of phosphate (i.e. cathodic protection) at cathodic area of metal surface. For deposition inhibition, given certain phosphate level for corrosion inhibition, a higher hardness requires a higher polymer level to prevent hardness precipitation in bulk water. A feedforward control strategy can be formulated such that when upsets change pH or calcium conditions, phosphate and polymer treatment levels are adjusted accordingly to maintain water and treatment chemistry within the “boxes” such that corrosion and deposition are prevented. FIG. 4 shows an example of predefined operating regions in a boiler system, coordinating feed water chemistry with feed water treatment chemistry by the following equation:

feed water polymer (ppm)=total hardness+(1.8×total iron), where feed water polymer level depends on feed water total hardness level plus 1.8 times feed water total iron level such that additional hardness and iron are compensated by increasing level of polymer to ensure hardness and iron are not precipitated inside the boiler.

In one embodiment of the present invention, the operating regions are comprised of uncontrollable variables and controllable variables. The uncontrollable variables are comprised of variables such as feed water or system water chemistry variables, such as pH, hardness, alkalinity, phosphate, iron, aluminum, total dissolved solid, total suspended solid, bacteria, and combinations thereof. The controllable variables are comprised of chemical treatment variables (feed rates, total and residual concentrations of corrosion inhibitor, deposition inhibitor and biocide), makeup water flow rates and blowdown water flow rates, and combinations thereof. The operating regions are defined by coordinating controllable variables with uncontrollable variables so that based on a priori knowledge about the correlation between water and treatment chemistry and equipment health, coordination within the operating region ensures inhibition of corrosion, scaling and fouling. The predefined operating regions are stored in a controller.

Water treatment chemicals vary depending on end use application. Chemical treatments known in the art may be utilized. For cooling tower applications these water treatment chemicals include, but are not limited to, phosphonates, phosphates and phosphoric acid anhydrides, biocides, corrosion inhibitors such as zinc and molybdenum salts and oxides and azoles, and alkali metal and alkaline earth hydroxides. For boiler water applications these water treatment chemicals include, but are not limited to, oxygen scavengers, such as sodium metabisulfite and hydrazine, phosphates and phosphoric acid anhydrides, chelants, such as EDTA, NTA or DTPA, and amines such as ammonia, morpholine and cyclohexylamine. For oil field applications these water treatment chemicals include, but are not limited to, amides, imidazolines, amidoamines, phosphonates, freezing point depressants such as methyl alcohol, ethylene glycol and propylene glycol, biocides, polyethylene glycols, polypropylene glycols and fatty acids. For waste water treatment these water treatment chemicals include, but are not limited to, coagulants, such as alum, poly(aluminum chloride) and iron salts, surfactants, biocides, and alkali metal and alkaline earth hydroxides. The level of treatment utilized depends upon the treatment level desired for the particular water system to be treated.

Polymers and copolymers can be utilized in combination with conventional water treatment agents, including but not limited to: phosphoric acids and water soluble salts thereof; phosphonic acids and water soluble salts thereof; amines; and oxygen scavengers. Examples of phosphoric acids include orthophosphoric acid, polyphosphoric acids such as pyrophosphoric acid, tripolyphosphoric acid and the like, metaphosphoric acids such as trimetaphosphoric acid, and tetrametaphosphoric acid. Examples of phosphonic acids include aminopolyphosphonic acids such as aminotrimethylene phosphonic acid, ethylene diamine tetramethylene phosphonic acid and the like, methylene diphosplionic acid, hydroxy ethylidene-1,1-diphosphonic acid, 2-phosphonobutane-1,2,4-tricarboxylic acid, etc. Examples of amines include morpholine, cyclohexylamine, piperazine, ammonia, diethylaminoethanol, dimethyl isopropanolamine, methylamine, dimethylamine, methoxypropylamine, ethanolamine, diethanolamine, and hydroxylamine sulfite, bisulfite, carbohydrazide, citric acid, ascorbic acid and salt analogs. Examples of oxygen scavengers include hydroquinone, hydrazine, diethylhydroxylamine, hydroxyalkylhydroxylamine, etc.

Polymers and copolymers may be added in combination with additional components, may be blended with additional chemical treatments, or may be added separately. Polymers and copolymers may be used in combination with conventional corrosion inhibitors for iron, steel, copper, copper alloys, or other metals, conventional scale and contamination inhibitors, metal ion sequestering agents, and other water treatment agents known in the art.

Treatment materials may include one or more chemical components. For example, a treatment material designed to inhibit corrosion may include at least one cathodic inhibitor, at least one anodic inhibitor, and/or at least one additional material, such as anti-scalant(s), surfactant(s) and anti-foam agent(s). Other treatment materials may include, but are not limited to, one or more acids, such as sulfuric acid, or one or more alkaline materials, such as a solution of caustic soda. Chemicals such as, and not limited to, ferrous and non-ferrous corrosion inhibitors, scale control agents, dispersants for inorganic and organic foulants, oxidizing and non-oxidizing biocides, biodispersants as well as specialized contingency chemicals to handle chemistry upsets due to process side ingressors may be utilized.

The more than one feed water or system water variable are comprised of variables such as makeup water flow rates and blowdown water flow rate, pH, hardness, alkalinity, phosphate, iron, aluminum, total dissolved solid, total suspended solid, bacteria, and combinations thereof. The at least one chemical treatment variable are comprised of variables such as feed rates, total and residual concentrations of corrosion inhibitor, deposition inhibitor, biocide, and combinations thereof.

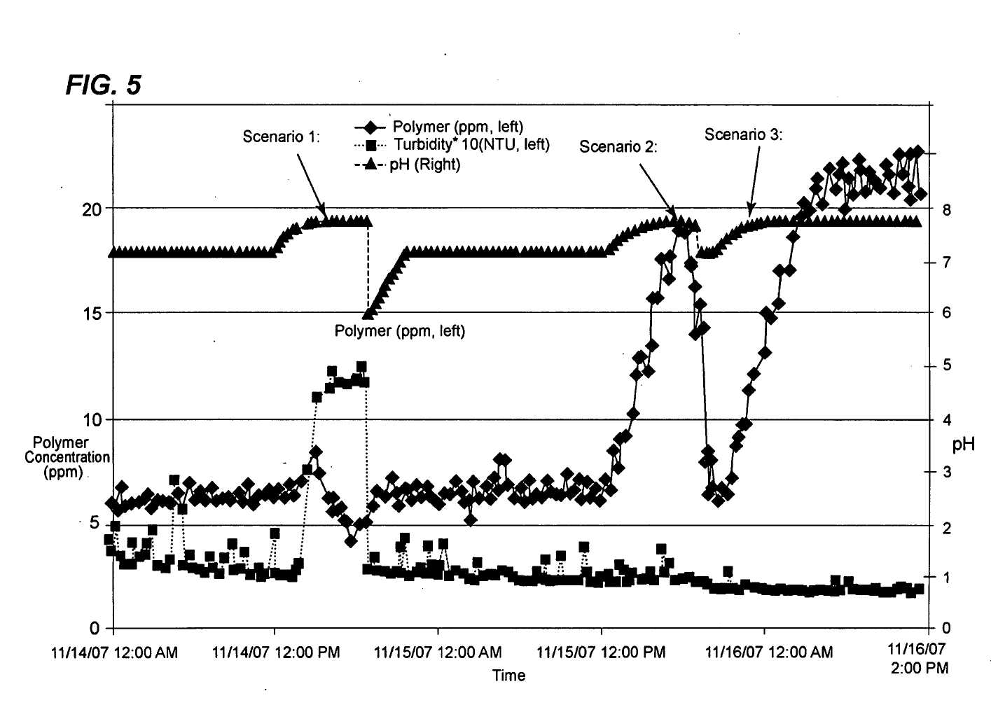

FIG. 5 shows a comparison between a proactive control system 105 with a priori knowledge of the correlation between pH and target polymer concentration and a reactive control system 10 without a priori knowledge. Scenario 1 depicts pH upset without a priori knowledge of the correlation between pH and target concentration of polymer. When pH increases from 7.2 to 7.8 in Scenario 1, polymer target does not change, which leads to precipitation of phosphate and an increase of turbidity, as indicated by suspended particles in water. After Scenario 1, pH decreases temporarily to dissolve particles before testing Scenario 2. Scenario 2 depicts pH upset with a priori knowledge of the correlation between pH and target concentration of polymer. In Scenario 2, when pH increases from 7.2 to 7.8, the polymer level increases from 6 ppm to 18 ppm accordingly. While increased pH reduces phosphate solubility, added polymer increases it. As a result, there is no precipitation of phosphate and no increase in turbidity, and the impact of upsets on phosphate solubility does not occur. Scenario 3 further depicts persistent pH upset with a priori knowledge of the correlation between pH and target concentration of polymer. In Scenarios 2 and 3, because a priori knowledge of the correlation between pH and target concentration of polymer is available, system polymer concentration is adjusted to the target concentration for increased pH, and thus there is no precipitation of phosphate or turbidity increase observed.

While the present invention has been described with references to preferred embodiments, various changes or substitutions may be made on these embodiments by those ordinarily skilled in the art pertinent to the present invention with out departing from the technical scope of the present invention. Therefore, the technical scope of the present invention encompasses not only those embodiments described above, but all that fall within the scope of the appended claims.

What is claimed is:

1. A control system for monitoring and controlling an industrial water system comprising:
(a) obtaining a priori knowledge about the correlation between water and treatment chemistry and equipment health;
(b) pre-defining a set of operating regions of more than one feed water or system water variable and at least one chemical treatment variable where, based on (a), corrosion, scaling and fouling are inhibited;
(c) adjusting said at least one chemical treatment variable according to said more than one feed water or system water variable, such that based on (a), corrosion, scaling, and fouling are inhibited

2. The control system of claim 1 wherein said industrial water system is a recirculating system.

3. The control system of claim 2 wherein said industrial water system is a cooling tower system or a boiler system.

4. The control system of claim 1 wherein said a priori knowledge is obtained by theoretically or empirically correlating water and treatment chemistry to equipment health.

5. The control system of claim 1 wherein said operating regions are comprised of uncontrollable variables and controllable variables.

6. The control system of claim 5 wherein said uncontrollable variables are comprised of feed water chemistry variables or system water chemistry variables.

7. The control system of claim 6 wherein said feed water chemistry variables or system water chemistry variables are comprised of pH, hardness, alkalinity, phosphate, iron, aluminum, total dissolved solid, total suspended solid, bacteria, and combinations thereof.

8. The control system of claim 5 wherein said controllable variables are comprised of chemical treatment variables, makeup water flow rates, blowdown water flow rates, and combinations thereof.

9. The control system of claim 8 wherein said chemical treatment variables are comprised of feed rates, total and residual concentrations of corrosion inhibitor, deposition inhibitor and biocide, and combinations thereof.

10. The control system of claim 1 wherein said operating regions are defined by coordinating controllable variables with uncontrollable variables, such that based on claim 1 subsection (a) obtaining a priori knowledge about the correlation between water and treatment chemistry and equipment health, coordination within said operating region insures inhibition of corrosion, scaling, and fouling.

11. The control system of claim 1 wherein said predefined operating regions are stored in a controller.

12. The control system of claim 1 wherein said more than one feed water or system water variables are comprised of makeup water flow rates, blowdown water flow rates, pH, hardness, alkalinity, phosphate, iron, aluminum, total dissolved solid, total suspended solid, bacteria, and combinations thereof.

13. The control system of claim 1 wherein said at least one chemical treatment variables are comprised of feed rates, total and residual concentrations of corrosion inhibitor, deposition inhibitor, biocide, and combinations thereof.
